(19) United States
(12) Patent Application Publication
(10) Pub. No.: US 2019/0025625 A1
(43) Pub. Date: Jan. 24, 2019

(54) LIQUID CRYSTAL DISPLAY

(71) Applicant: Wuhan China Star Optoelectronics Technology Co., Ltd., Hubei (CN)

(72) Inventor: Biao PAN, Shenzhen (CN)

(73) Assignee: Wuhan China Star Optoelectronics Technology Co., Ltd., Hubei (CN)

(21) Appl. No.: 16/035,761

(22) Filed: Jul. 16, 2018

Related U.S. Application Data
(63) Continuation of application No. PCT/CN2018/074124, filed on Jan. 25, 2018.

(30) Foreign Application Priority Data
Jul. 20, 2017 (CN) 201710599945.3

(51) Int. Cl. G02F 1/1335

(52) U.S. Cl. CPC G02F 1/13362; G02F 2201/501; G02F 2202/022; G02F 2202/108; G02F 2001/133614

(57) ABSTRACT

A liquid crystal display includes a quantum bar film arranged between a lower polarizer and a backlight module. Quantum bars contained in the quantum bar film absorb backlighting generated by the backlight module and then emit polarized light having the same direction as an alignment direction of the quantum bars. The alignment direction of the quantum bars is set in the same direction as a direction of a polarization axis of the lower polarizer, so that the backlighting that transmits through the quantum bar film may largely pass through the lower polarizer to thereby reduce light absorbed by the lower polarizer and increase light transmission rate of the backlighting generated by the backlight module to pass through the lower polarizer, thus enhancing utilization of the backlighting and improving brightness of the liquid crystal display.

### CROSS REFERENCE TO RELATED APPLICATIONS

This is a continuation application of PCT Application No. PCT/CN2018/074124, filed on Jan. 25, 2018, claiming foreign priority of Chinese Patent Application No. 201710599945.3 filed on Jul. 20, 2017.

### BACKGROUND OF THE INVENTION

### 1. Field of the Invention

The present invention relates to the field of liquid crystal display technology, and more particularly to a liquid crystal display.

### 2. The Related Arts

A liquid crystal display comprises a liquid crystal panel and a backlight module that are stacked on each other. Also, a lower polarizer is arranged between the liquid crystal panel and the backlight module to make backlighting generated by the backlight module incident onto the liquid crystal panel in a specific polarization direction. For the state of the art, the lower polarizer is generally an absorptive polarizer, and non-polarized light emitting from the backlight source has a component in the direction of an absorption axis of the lower polarizer that will be absorbed and will not be allowed to pass when transmitting through the lower polarizer. Consequently, light transmittance of the lower polarizer with respect to the backlighting generated by the backlight module is, theoretically, not greater than 50%. The light, after passing through the liquid crystal panel, will provide the liquid crystal display with brightness that is generally not greater than 10% of the brightness of the backlighting emitting from the backlight module to be actually observed by a user. Thus, the utilization of the backlighting is generally extremely low and this is a waste of energy.

Quantum bar is a nanometer conductive material and has a shape that is a one-dimensional structure. What is different from the generally absorptive polarizers that absorb non-polarized light and emit heat is that the quantum bar, after absorbing the non-polarized light, may be excited, in a major axis thereof, to emit polarized light having a wavelength that is longer than that of the incident light. Also, the quantum bar has high internal quantum efficiency and is thus capable of converting a large amount of non-polarized light into polarized light that has a direction matching the axial direction thereof.

### SUMMARY OF THE INVENTION

The present invention provides a liquid crystal display, which improves the utilization of backlighting.

The liquid crystal display comprises a backlight module. A quantum bar film, a lower polarizer, and a liquid crystal panel are stacked, in sequence, on the backlight module. The lower polarizer comprises a plurality of polarization axes arranged in an array. The quantum bar film comprises a plurality of quantum bar film units arranged in an array. Each of the quantum bar film units corresponds to one of the polarization axes. Among the plurality of quantum bar film units, at least some quantum bar film units contain quantum bars, while the other quantum bar film units contain liquid crystal molecules. The quantum bars or the liquid crystal molecules contained in the quantum bar film units have alignment directions that are identical to directions of the polarization axes corresponding to the quantum bar film units.

In the above, the liquid crystal panel comprises a number of red sub-pixel units, a number of blue sub-pixel units, and a number of green sub-pixel units arranged in an array. The plurality of quantum bar film units are divided into a number of red quantum bar film units, a number of blue quantum bar film units, and a number of green quantum bar film units. The red quantum bar film units correspond, in a one to one manner, to the red sub-pixel units. The blue quantum bar film units correspond, in a one to one manner, to the blue sub-pixel units. The green quantum bar film units correspond, in a one to one manner, to the green sub-pixel units.

In the above, the backlight module generates backlighting that comprises blue light.

In the above, the red quantum bar film units and the green quantum bar film units both comprise a plurality of quantum bars, while the blue quantum bar film units comprise a plurality of liquid crystal molecules.

In the above, the quantum bars comprise one or multiple ones of elements of groups III-V, groups II-VI, and groups IV-VI of the periodic table.

In the above, the quantum bars have a length of 10 nm-50 nm and a length-to-diameter ratio of 5-10.

In the above, the quantum bar film has a thickness of 0.5 μm-2 μm.

In the above, the quantum bar film has two opposite sides on which a first blocking layer and a second blocking layer are stacked respectively.

In the above, the first blocking layer and the second blocking layer are made of a material comprises one of poly(ethylene terephthalate) polymer, poly(methyl methacrylate) polymer, epoxy resin polymer, polysiloxanes polymer, fluorine resin polymer, and organic/inorganic compound film containing metal oxides.

In the above, the quantum bar film further comprises a spacing layer, and every two adjacent ones of the quantum bar film units are separated by the spacing layer, the spacing layer comprising a light shielding material.

The present invention provides a liquid crystal display, which comprises a quantum bar film arranged between a lower polarizer and a backlight module. Quantum bars contained in the quantum bar film absorb backlighting generated by the backlight module and then emit polarized light having the same direction as an alignment direction of the quantum bars. The alignment direction of the quantum bars is set in the same direction as a direction of a polarization axis of the lower polarizer, so that the backlighting that transmits through the quantum bar film may largely pass through the lower polarizer to thereby reduce light absorbed by the lower polarizer and increase light transmission rate of the backlighting generated by the backlight module to pass through the lower polarizer, thus improving brightness of the liquid crystal display and enhancing utilization of the backlighting.

### BRIEF DESCRIPTION OF THE DRAWINGS

To more clearly explain the technical solution proposed in an embodiment of the present invention and that of the prior art, a brief description to the drawings that are necessary for describing the embodiment or the prior art is given as follows. It is obvious that the drawings that will be described below show only some embodiments of this application. For those having ordinary skills of the art, other obvious variations may be readily available from these attached drawings without the expense of creative effort and endeavor.

FIG. 1 is a schematic cross-sectional view illustrating a liquid crystal display according to an embodiment of the present invention; and

FIG. 2 is a schematic cross-sectional view illustrating a quantum bar film according to the embodiment of the present invention.

### DETAILED DESCRIPTION OF THE PREFERRED EMBODIMENTS

A clear and complete description will be given to technical solutions provided by embodiments of the present invention with reference to the attached drawings of the embodiments of the present invention. However, the embodiments so described are only some, but not all, of the embodiments of the present invention. Other embodiments that are available to those having ordinary skills of the art without the expense of creative effort and endeavor are considered belonging to the scope of protection of the present invention.

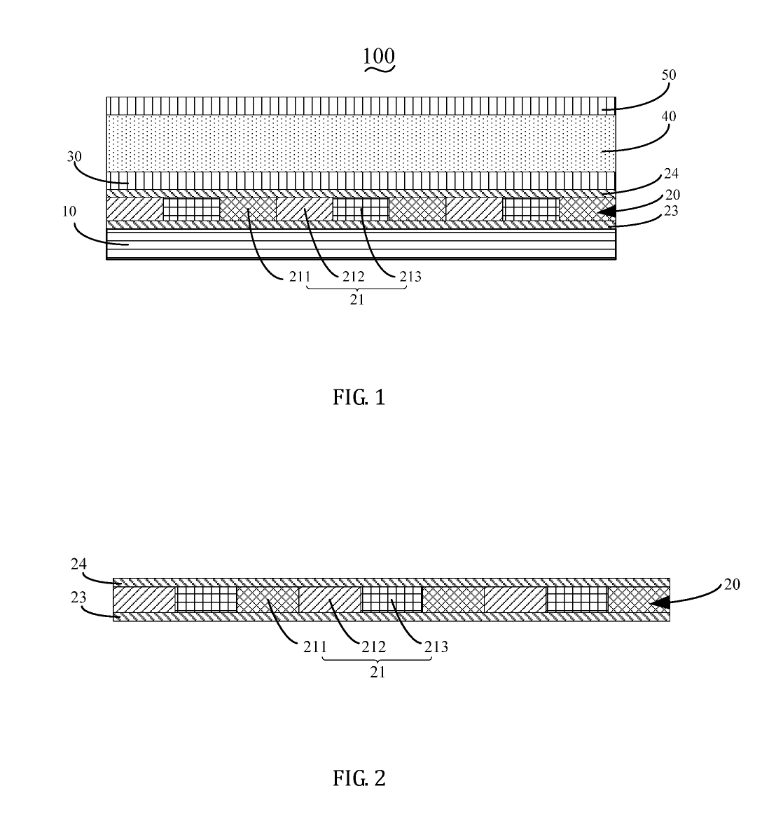

Referring to FIG. 1, the present invention provides a liquid crystal display 100. The liquid crystal display 100 comprises a backlight module 10, a quantum bar film 20, a lower polarizer 30, a liquid crystal panel 40, and the upper polarizer 50, which are stacked in sequence. The quantum bar film 20 is located between the lower polarizer 30 and the backlight module 10. The backlight module 10 generates backlighting that transmits through the quantum bar film 20 and the lower polarizer 30 to get incident onto the liquid crystal panel 40, and then exits through the upper polarizer 50 to fulfill displaying on the liquid crystal display 100. The more the light exiting from the upper polarizer 50 is, the higher the display brightness of the liquid crystal display 100 will be. In the instant embodiment, illumination incident onto the liquid crystal panel 40 is made increased in order to increase the light passing the upper polarizer 50.

The backlight module 10 comprises a backlight source, a light guide plate, and the likes. Backlighting emitting from the backlight module 10 is generally non-polarized light. In the present invention, the backlighting generated by a backlight source of the backlight module 10 is blue light. Blue light has a relatively short wavelength and may excite quantum bars, upon transmitting therethrough, to emit green light or red light having a wavelength longer than that of the original blue light, in order to meet the needs of image displaying on the liquid crystal display 100. In the instant embodiment, the backlight source is a blue LED light. Compared to a conventionally used white LED light (which is generally a blue LED chip added with yellow fluorescent powder to provide white light), the blue LED light adopted in the instant embodiment does not need to include fluorescent powder so that the amount of optical energy that could be absorbed by the fluorescent powder can be saved to thereby increase the light-electricity conversion efficiency of the backlight module 10 and thus heightening color saturation (NTSC) of the liquid crystal display 100.

Referring collectively to FIGS. 1 and 2, the quantum bar film 20 comprises a plurality of quantum bar film units 21 arranged in an array. The plurality of quantum bar film units 21 are divided into a number of red quantum bar film units 211, a number of blue quantum bar film units 212, and a number of green quantum bar film units 213. A sum of the number of the red quantum bar film units 211, the number of the blue quantum bar film units 212, and the number of the green quantum bar film units 213 is the number of the quantum bar film units 21. Also, the red quantum bar film units 211, the blue quantum bar film units 212, and the green quantum bar film units 213 are arranged alternate with one another. In the present invention, the quantum bar film 20 further comprises a spacing layer, such that every two adjacent ones of the quantum bar film units 21 are separated by the spacing layer. The spacing layer comprises a light shielding material. In the instant embodiment, the spacing layer comprises a mixture of Cr/acrylic resin and a black colorant (BM). In the instant embodiment, the quantum bar film layer 20 has a thickness of 0.5 μm-2 μm, in order to ensure the fulfillment of the function of the quantum bar film 20 in a condition of being as thin as possible. The quantum bar film layer 20 is provided, stacked on two opposite sides thereof, with a first blocking layer 23 and a second blocking layer 24. The first blocking layer 23 and the second blocking layer 24 protect the quantum bar film layer 20 to achieve resistance against humidity and corrosion for the quantum bar film layer 20. The first blocking layer 23 and the second blocking layer 24 are transparent film layers, and this allows the backlighting to easily transmit through the first blocking layer 23 and the second blocking layer 24. The first blocking layer 23 and the second blocking layer 24 are made of a material comprises one of poly(ethylene terephthalate) polymer, poly(methyl methacrylate) polymer, epoxy resin polymer, polysiloxanes polymer, fluorine resin polymer, and organic/inorganic compound film containing metal oxides. In the instant embodiment, the first blocking layer 23 and the second blocking layer 24 are PET (polyethylene terephthalate) films, which provide excellent protection of the quantum bar film layer 20 and also achieve high transmission rate for the backlighting.

At least a portion of the plurality of quantum bar film units 21 contain quantum bars, while the other quantum bar film units 21 contain liquid crystal molecules. Specifically, among the plurality of quantum bar film units 21, at least a portion of quantum bar film units 21 contain quantum bars, while the other portion contain liquid crystal molecules. Or alternatively, each of the quantum bar film units 21 contains quantum bars. Also, the quantum bars or the liquid crystal molecules contained in the quantum bar film unit 21 have an alignment direction that is identical to a polarization axis that corresponds to the quantum bar film unit 21. In the instant embodiment, the red quantum bar film units 211 and the green quantum bar film units 213 both contain a plurality of quantum bars therein, while the blue quantum bar film units 312 contain therein a plurality of liquid crystal molecules. The quantum bars contained in the red quantum bar film units 211 and the green quantum bar film units 213 and the liquid crystal molecules contained in the blue quantum bar film units 312 all have predetermined alignment directions. Alignment of the quantum bars can be achieved with a known way for aligning liquid crystal molecules and description thereof will be omitted herein.

Further, in the instant embodiment, the quantum bars of the red quantum bar film units 211 and the quantum bars of the green quantum bar film units 213 have different compositions or different sizes so that the blue backlighting generated by the backlight module 10, after being absorbed by the quantum bars of the red quantum bar film units 211 may cause excitation to give off red polarized light and the blue backlighting generated by the backlight module 10, after being absorbed by the quantum bars of the green quantum bar film units 213 may cause excitation to give off green polarized light. Also, the red polarized light has a polarization direction that is identical to the alignment direction of the quantum bars of the red quantum bar film units 211; and the green polarized light has a polarization direction that is identical to the alignment direction of the quantum bars of the green quantum bar film units 213. The blue quantum bar film units 212 contain therein liquid crystal molecules, so as not to cause a change of wavelength of the blue light that transmits through the blue quantum bar film units 212 thereby ensuing no loss of optical energy. Also, the liquid crystal molecules cause alignment of light for the blue light entering the blue quantum bar film units 212 so that blue polarized light may be generated after the transmission thereof through the blue quantum bar film units 212, and a polarization angle of the blue polarized light is identical to an alignment angle of the liquid crystal molecules.

In the present invention, the quantum bars are semiconductor materials and the semiconductor materials are compounds composed of one or multiple ones of elements of groups III-V group, groups II-VI, and groups IV-VI of the periodic table. In the instant embodiment, the quantum bars of the red quantum bar film units 211 are formed of a CdSe/CdS material and the quantum bars of the green quantum bar film units 213 are formed of a CdSe/InP material. Further, the quantum bars have a length of 10 nm-50 nm and a length-diameter ratio of 5-10. It is appreciated that the length and length-diameter ratio of the quantum bars can be varied in accordance with actual requirements.

The lower polarizer 30 comprises a plurality of polarization axes arranged in an array. The arrayed polarization axes and the arrayed quantum bar film units 21 correspond to each other in a one-to-one manner, meaning each of the quantum bar film units 21 corresponds to one of the polarization axes. Also, the alignment directions of the quantum bars or the liquid crystal molecules contained in the quantum bar film unit 21 are identical to the directions of the polarization axes corresponding to the quantum bar film units 21. The polarization direction of the red polarized light emitting from the red quantum bar film unit 211 is identical to the alignment direction of the quantum bars of the red quantum bar film unit 211; the polarization direction of the green polarized light emitting from the green quantum bar film unit 213 is identical to the alignment direction of the quantum bars of the green quantum bar film unit 213; and the polarization angle of the blue polarized light transmitting through the liquid crystal molecules of the blue quantum bar film unit 212 is identical to the alignment angle of the liquid crystal molecules, so that the polarization direction of the red polarized light emitting from the red quantum bar film unit 211 is the same as the direction of the polarization axis corresponding to the red quantum bar film unit 211; the polarization direction of the green polarized light emitting from the green quantum bar film units 213 is the same as the direction of the polarization axis corresponding to the green quantum bar film units 213; and the polarization angle of the blue polarized light transmitting through the liquid crystal molecules of the blue quantum bar film unit 212 is the same as the angle of the polarization axis corresponding to the blue quantum bar film unit 212. Generally, the polarized light in the direction of the polarization axis can basically transmit through the lower polarizer 30, and thus, the red polarized light, the blue polarized light, and the green polarized light that emit from the red quantum bar film units 211, the blue quantum bar film units 212, and the green quantum bar film units 213 can largely transmit through the lower polarizer 30. Compared to the conventional lower polarizer that has a light transmission rate allowing backlighting generated by a backlight module to transmit therethrough by theoretically no greater than 50%, the present invention, through an arrangement of a quantum bar film between a backlight module and a lower polarizer, greatly increases the light transmission rate of the backlighting generated by the backlight module 10 transmitting through the lower polarizer. Tests reveal that the lower polarizer of the instant embodiment provides a light transmission rate of up high to 80% for backlighting generated by a backlight module to transmit therethrough.

The liquid crystal panel 40 comprises a plurality of red sub-pixel units, a plurality of blue sub-pixel units, and a plurality of green sub-pixel units (not shown) arranged in an array. The red sub-pixel units, the blue sub-pixel units and the green sub-pixel units are arranged alternate with one another. The red quantum bar film units 211 correspond, in a one to one manner, to the red sub-pixel units so that the red polarized light emitting from the red quantum bar film units 211 passes through the lower polarizer 30 and gets incident onto areas of the red sub-pixel units. The blue quantum bar film units 212 correspond, in a one to one manner, to the blue sub-pixel units so that the blue polarized light emitting from the blue quantum bar film units 212 passes through the lower polarizer 30 and gets incident onto areas of the blue sub-pixel units. The green quantum bar film units 213 correspond, in a one to one manner, to the green sub-pixel units so that the green polarized light emitting from the green quantum bar film units 213 passes through the lower polarizer 30 and gets incident onto areas of the green sub-pixel units.

The liquid crystal panel 40 is provided, on one side thereof where light exits, with the color filter substrate, and light from the liquid crystal panel 40 passes through the color filter substrate to exit. The color filter substrate comprises a plurality of arrayed red color filter zones, blue color filter zones, and green color filter zones. The red color filter zones correspond to the red sub-pixel units; the blue color filter zones correspond to the blue sub-pixel units; and the green color filter zones correspond to the green sub-pixel units. Generally, different color filter zones of the color filter substrate filter off light having a color different therefrom and allow light having the same color to pass therethrough so as to display three primary colors, red, blue, and green, on the liquid crystal panel, allowing the liquid crystal panel to display an effect of rich colorfulness. In the state of the art, backlighting is generally white light, meaning light entering the color filter zones of the color filter substrate includes all color components and a majority of the light would be filtered off by the color filter substrate. However, in the present invention, different ones of the quantum bar film units 21 of the quantum bar film 20 respectively correspond to the sub-pixels of the same colors as those thereof. In other words, light entering the color filter zones of the color filter substrate is light having the same color as that of the color filter zone of the color filter substrate. Thus, the amount of light that is filtered off by the color filter substrate is greatly reduced to thereby heighten the color saturation (NTSC) of the liquid crystal display 100. For example, the red quantum bar film units 211 correspond to the red sub-pixels and also correspond to the red color filter zones of the color filter substrate. The quantum bars contained in the red quantum bar film units 211 are excited by the blue backlighting to emit the red polarized light for transmission into the red color filter zones of the color filter substrate. Since the red polarized light and the red color filter zones of the color filter substrate are of the same color, the amount of light filtered off by the color filter substrate is greatly reduced to thereby heighten color saturation (NTSC) of the liquid crystal display 100.

The present invention provides a liquid crystal display 100, which comprises a quantum bar film 20 arranged between a lower polarizer 30 and a backlight module 10. Quantum bars contained in the quantum bar film 20 absorb backlighting generated by the backlight module 10 and then emit polarized light having the same direction as an alignment direction of the quantum bars. The alignment direction of the quantum bars is set in the same direction as a direction of a polarization axis of the lower polarizer 30, so that the backlighting that transmits through the quantum bar film may largely pass through the lower polarizer 30 to thereby reduce light absorbed by the lower polarizer 30 and increase light transmission rate of the backlighting generated by the backlight module 10 to pass through the lower polarizer 30, thus improving brightness of the liquid crystal display 100 and enhancing utilization of the backlighting. Also, in the present invention, the light source of the backlight module 10 is blue LEDs that do not carry fluorescent powders so as to greatly increase light-electricity conversion efficiency of the backlight source and reduce power consumption of the backlighting to thereby increase color saturation (NTSC) of the liquid crystal display 100. Also, the quantum bars of the quantum bar film 20 are excited by the blue light incident onto the quantum bar film units 21 to emit light having the colors that are the same as different color sub-pixels corresponding to the quantum bar film units to thereby reduce the effect of light filtering by the color filter substrate of the liquid crystal panel 40 so as to further improve color saturation (NTSC) of the liquid crystal display 100.

The present invention has been described with reference to the preferred embodiments. However, it is noted that those skilled in the art would appreciates that various improvements and modifications are still available without departing from the scope of the present invention and such improvements and modifications are considered within the scope of protection of the present invention.

What is claimed is:

1. A liquid crystal display, comprising a backlight module, a quantum bar film, a lower polarizer, and a liquid crystal panel being stacked, in sequence, on the backlight module, the lower polarizer comprising a plurality of polarization axes arranged in an array, the quantum bar film comprising a plurality of quantum bar film units arranged in an array, each of the quantum bar film units corresponding to one of the polarization axes, wherein among the plurality of quantum bar film units, at least some quantum bar film units contain quantum bars, while the other quantum bar film units contain liquid crystal molecules, the quantum bars or the liquid crystal molecules contained in the quantum bar film units having alignment directions that are identical to directions of the polarization axes corresponding to the quantum bar film units.

2. The liquid crystal display according to claim 1, wherein the liquid crystal panel comprises a number of red sub-pixel units, a number of blue sub-pixel units, and a number of green sub-pixel units arranged in an array, and the plurality of quantum bar film units are divided into a number of red quantum bar film units, a number of blue quantum bar film units, and a number of green quantum bar film units, the red quantum bar film units corresponding, in a one to one manner, to the red sub-pixel units, the blue quantum bar film units corresponding, in a one to one manner, to the blue sub-pixel units, the green quantum bar film units corresponding, in a one to one manner, to the green sub-pixel units.

3. The liquid crystal display according to claim 2, wherein the backlight module generates backlighting that comprises blue light.

4. The liquid crystal display according to claim 3, wherein the red quantum bar film units and the green quantum bar film units both comprise a plurality of quantum bars, while the blue quantum bar film units comprise a plurality of liquid crystal molecules.

5. The liquid crystal display according to claim 1, wherein the quantum bars comprise one or multiple ones of elements of groups III-V, groups II-VI, and groups IV-VI of the periodic table.

6. The liquid crystal display according to claim 1, wherein the quantum bars have a length of 10 nm-50 nm and a length-to-diameter ratio of 5-10.

7. The liquid crystal display according to claim 1, wherein the quantum bar film has a thickness of 0.5 μm-2 μm.

8. The liquid crystal display according to claim 1, wherein the quantum bar film has two opposite sides on which a first blocking layer and a second blocking layer are stacked respectively.

9. The liquid crystal display according to claim 8, wherein the first blocking layer and the second blocking layer are made of a material comprises one of poly(ethylene terephthalate) polymer, poly(methyl methacrylate) polymer, epoxy resin polymer, polysiloxanes polymer, fluorine resin polymer, and organic/inorganic compound film containing metal oxides.

10. The liquid crystal display according to claim 1, wherein the quantum bar film further comprises a spacing layer, and every two adjacent ones of the quantum bar film units are separated by the spacing layer, the spacing layer comprising a light shielding material.
